(19) United States
(12) Patent Application Publication
(10) Pub. No.: US 2004/0103073 A1
(43) Pub. Date: May 27, 2004

(54) System for and method of using component-based development and web tools to support a distributed data management system

(76) Inventors: M. Brian Blake, Vienna, VA (US); Gail Hamilton, Arlington, VA (US); Jeffrey Hoyt, Herndon, VA (US)

Correspondence Address: Choate, Hall & Stewart, Exchange Place, 53 State Street, Boston, MA, 02109, US

(21) Appl. No.: 10/301,289

(22) Filed: Nov. 21, 2002

(51) Int. Cl. G06F 7/00

(52) U.S. Cl. 707/1

(57) ABSTRACT

A system for and method of using component-based development and web tools to support a distributed data management system. The system comprises a run-time evolvable distributed database management architecture including a data storage layer including a database management system for managing a database, a dynamic generator of an HTML-based interface to the data storage layer based upon user preferences and database-specific information, and a control module including one or more autonomous business components, the control module for creating at run-time a workflow sequence for executing the autonomous business components and executables of the data storage layer in response to instructions received via the interface in order to retrieve and format data from the database.

### FIELD OF THE INVENTION

The present invention relates generally to relational database management systems, and more particularly to the run-time evolvable access interfaces to large database systems.

### BACKGROUND OF THE INVENTION

With the onset of distributed computing environments, data management at the enterprise-level has become a major issue. “Internet-able” applications have been used to support domains where distributed functionality is essential. Almost every domain has become dependent on the need for information resources. Domains ranging from finance to engineering to medical services and many more have a necessity for current and accurate data. With the increase in distributed computing, this data must also be available across multiple enterprise locations and geographical regions. Typically, in these domains both the schema of the data repository and the individual query needs of the users evolve over time.

Database management systems (DBMSs) have advanced to handle storage, managing, querying, and concurrency handling of raw data. DBMSs also allow the data to be accessed from distributed locations. Unfortunately, the support given by DBMSs is not sufficient for domains where complex business rules and derivation must occur prior to making the information available to the enterprise-wide stakeholders. Thus, what is needed is a distributed data management system that couples the benefits of a DBMS with the flexibility of a run-time evolvable component-based support architecture.

At present, many databases have tools 100 and architectures to support the development of web-based graphical user interfaces (GUIs) 102 that can access their own DBMS 104 (e.g., WebDB 3.0 of the Oracle Corporation™), as depicted in the simplified architecture 101 of FIG. 1. In architecture 101, the DBMS 104 supplies an interface generation tool 100 that gives a user the option of creating their own GUI 102. The tool presents actual schema information 106 and the user configures the GUI 102 depending on his/her needs. This is a scaleable solution because as the database schema changes, the user can develop new GUIs to support those changes. The DBMS 104 also allows the development of database functions or packages that can be used to derive raw data. These functions run internal to the database server. Moreover, these systems support the return of multiple data formats (i.e., HTML, Delimited text, XML, etc.)

Architectures such as architecture 101, though extensible, are not sufficient for all distributed data needs. Users attempting to apply this generic DBMS solution to their needs may encounter a number of limitations.

Some data requests are for many megabytes of information that must undergo a rigorous process to derive original data into more useful information. Using internal database packages and/or functions to perform these derivations can greatly decrease the performance of the DBMS when multiple users are requesting large database jobs. What is needed is an architecture that can support the rigor of large and/or complex data derivations.

Some enterprise stakeholders need output in formats that are specific to their custom applications. Although the notion of a standard data representation is agreeable to all, this notion is not the current reality. What is needed is a domain that is able to support past, present, and future data formats whether they are standard formats (i.e., HTML, XML, delimited text, etc.) or custom user-specified formats.

Some data requests require the dynamic generation of multiple queries, due to the introduction of business rules. Some users require queries that cannot be generated without outside intervention. There must be some additional humans-in-the-loop to supply critical information to complete the query. An architecture that allows for the introduction of such business rules or outside intervention would, therefore, be beneficial.

Some applications need to stream information directly into their applications. The streaming process varies for different custom applications or simulations. Current DBMS solutions do not support data streaming requirements. In addition, the streaming functionality would probably cause additional performance decreases. Thus, an architecture that supports direct database connections and streaming is needed.

Several applications exist for navigating through a raw relational database (e.g., Oracle Navigator™, and U.S. Pat. No. 6,038,566 to Tsai), but they do not involve the creation of query forms. Their use with large scientific databases would be impractical, and the GUIs are directed more toward the quick publication of relational DBMS data on the Web.

U.S. Pat. No. 6,430,556 to Goldberg et al. discloses a query object generator tool that generates interface definitions and code that implements a query object and generates a GUI for controlling the generator tool and plug-in objects, including a database schema access query object for allowing the GUI to operate with vendor-specific databases. However, that system lacks an implementation of workflow and the ability to plug in new business-based functionality as objects. The system essentially generates objects that can be plugged into a larger application.

There are several research projects that are working towards tool support for relational database applications. The Zelig project introduces a schema that can be coupled with HTML to control various CGI-based database executables. (Varela, et al., “Zelig: Schema-Based Generation of Soft WWW Database Applications”, Proceedings of the 1^{st} International Conference of the World Wide Web, 1994, Elsevier Science, Geneva, Switzerland.) However, the Zelig project tightly couples the interface to the database by hard-coding entire query strings into the HTML documents. The interface merely has components of the query, while the middle-level components encapsulate generic and unspecific intelligence to build query strings. Nor does the system have the flexibility to allow additional business-specific components to be plugged in to further format and process the database results. Moreover, the Zelig implementation does not makes use of later, more flexible technologies such as XML and Java™ Servlets (Sun Microsystems Inc., 2002, Java Language Specification and the Distributed Event Model Specification).

The WebInTool architecture specifies a web-to-database interface-building tool. (Hu, et al., “WebInTool: A Generic Web to Database Interface Building Tool”, In Proceedings of the 7^{th} International Conference and Workshop on Database and Expert System Applications, 1996, IEEE Computer Society Press, Zurich, Switzerland.) That implementation promotes a separation of interface and back-end source code, but as in the Zelig project, there is no intelligent query building knowledge in the CGI-based modules. Thus, the architecture lacks an ability to dynamically create a large range of queries. In addition, since query strings are not incorporated in the WebInTool interface, users must have intimate knowledge of both the software (CGI) modules and of the underlying database schema to build new forms.

### SUMMARY OF THE INVENTION

The present invention is a system for and method of distributed data management. The system uses an on-going, component-based architecture to support the evolving needs of a user. The system also incorporates the benefits of a DBMS solution.

In one embodiment, the present invention comprises a run-time evolvable distributed database management architecture, including a data storage layer including a database management system for managing a database, a dynamic generator of an HTML-based interface to the data storage layer based upon user preferences and database-specific information, and a control module including one or more autonomous business components, the control module for creating at run-time a workflow sequence for executing the autonomous business components and executables of the data storage layer in response to instructions received via the interface in order to retrieve and format data from the database.

The database-specific information may include meta-information relating to tables of the database. Preferably, the meta-information has been automatically extracted from the database.

Workflow component configuration and execution information based upon the user preferences and the database-specific information is embedded within the standard mark up syntax of the interface. The workflow information is preferably comprised of a hidden tag and a control XML file. The XML file is processed with a deployment specific XSL file to dynamically generate the interface.

The control module further comprises Java servlets and classes to reflectively convert the instructions into a workflow sequence. The control module is evolvable to allow addition of new executable business components at run-time. The new business components are added by derivation and by inclusion of a name and associated execution links in the control XML file. Each of the autonomous business components perform independent database data specification or extraction tasks, and each includes a polymorphic executable interface callable by the control module. Some of the functions performed by the autonomous business components include specifying the desired data, extracting specific database table information from the user instructions, building joins between tables of the database, and formatting of data retrieved from the database. One or more of the autonomous business components perform domain specific functions, such as capturing user instructions entered employing directly the language of the database management system or further processing of data received from the database prior to providing it to a user.

The architecture's dynamic generator further comprises a set of servlets for accepting the user preferences from a browser and parsing the user preferences in order to generate specifications for new parts of the interface. The architecture interface comprises a network-accessible query form for display on a user screen and the instructions comprise query inputs. The dynamic generator has access to the database management system, and operates so as to present a query-form-building interface including selectable database-specific information, and generate an XML file based on information selected through the query-form-building interface.

Execution of the autonomous business components per the workflow sequence can be called from a Java servlet, applet, or a local or remote application. The execution can result in the generation of one or more dynamic queries for processing by the database management system. The execution may also result in the incorporation of business rules in the dynamically generated queries, custom formatting of data extracted from the database in accordance with the user instructions, and/or data streaming of the data extracted from the database to external applications.

In another aspect, the present invention is a new meta-language operable in a computer for extending a distributed data management system. The language includes a text-based syntax combining graphical user interface development semantics and database query semantics, wherein the syntax allows embedding of workflow component configuration and execution information based upon user preferences and database-specific information within a standard mark-up syntax of a graphical interface. An interpreter translates portions of the syntax and received user inputs into a query to a database.

In another aspect, the present invention is a method of extending a database management system by providing a run-time evolvable distributed database management architecture. An interface is provided to a data storage layer including a database management system for managing a database. An HTML-based interface to the data storage layer based upon user preferences and database-specific information is dynamically generated, and then at run-time, with the aid of one or more autonomous business components, a workflow sequence is created for executing the autonomous business components and executables of the data storage layer in response to instructions received via the interface in order to retrieve and format data from the database.

### BRIEF DESCRIPTION OF THE DRAWING

Embodiments of the present invention are explained in greater detail below on the basis of FIGS. 1 through 14 of the attached drawing, where:

FIG. 1 is a block diagram of a prior art web-accessible DBMS architecture;

FIG. 2 is a block diagram of a high-level architecture of a data management system in accordance with the present invention;

FIG. 3 is a block and process flow diagram illustrating a process for building query forms;

FIGS. 4A-B are examples of HTML code that implement portions of a query form;

FIG. 5 is a screenshot of a portion of an interface form;

FIG. 6 is a high-level diagram illustrating packages/components and underlying classes in an embodiment of the middle layer of an architecture in accordance with the present invention;

FIG. 7 is a class diagram illustrating an embodiment of the MainControl package in accordance with an architecture in accordance with the present invention;

FIG. 8 is an overview of the functionality of an embodiment of the MainControl Package;

FIG. 9 is a object collaboration diagram of an embodiment of the Parser_ObjectBuilder Package;

FIG. 10 is a high-level diagram of the organization and “message flow” of the CRS system architecture;

FIG. 11 is a screenshot of a sample HTML-based data retrieval form for the CRS system;

FIG. 12 is a low-level class diagram of an embodiment of Output Module;

FIG. 13 is an object collaboration diagram of an embodiment of the data extraction process; and

FIG. 14 is a screenshot showing the results of a sample query from the CRS system.

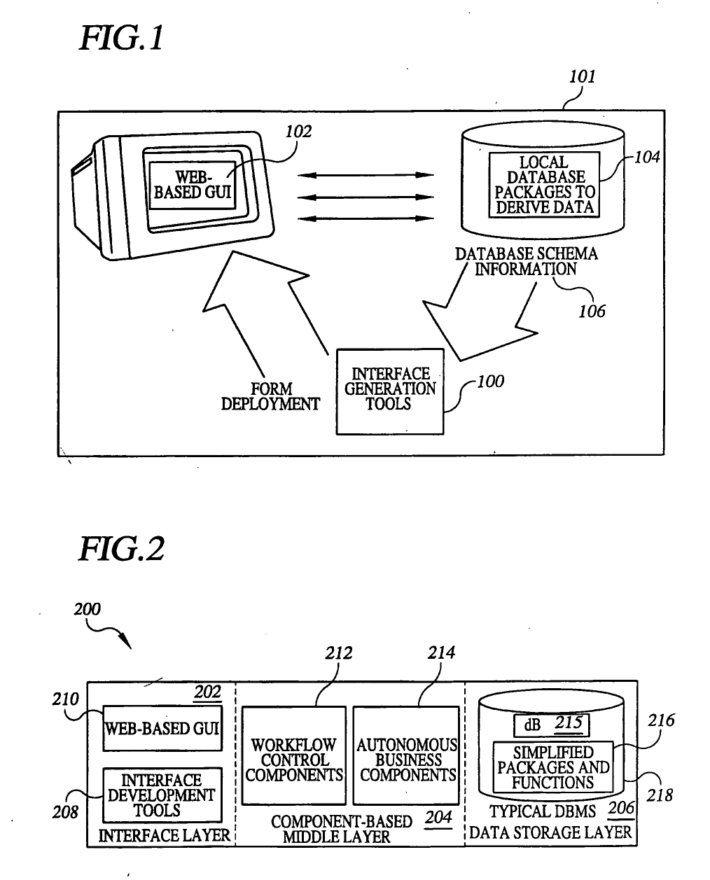

### DETAILED DESCRIPTION OF PREFERRED EMBODIMENTS OF THE INVENTION

Specific preferred embodiments of the present invention will now be described that are intended to be merely exemplary and in no manner limiting. The present invention is a result of the development of the architecture of a distributed data management system that supports the Center for Advanced Aviation System Development (CAASD) of The MITRE Corporation, assignee of the present invention. This component-based run-time configurable architecture is implemented using web-based technologies, such as the Extensible Markup Language (XML), Java Servlets, and a relational database management system (RDBMS). At CAASD, researchers develop simulations for both design-time and real-time analysis. This research constitutes a wealth of knowledge in the area of air traffic management and control. This division of MITRE is split into a large number of individual groups that investigate various problems comprising the air traffic domain. Although the groups analyze different problems, the data to support the investigations are typically the same. Also, these individual groups develop simulations that require the data in different formats (i.e., specialized text files with delimited data, database format, XML with a custom schema, etc.) Moreover, each group looks at different subsets of data that may cross multiple data sources. Researchers are currently provided with data that is gathered from outside sources and distributed by a data librarian. This data is usually distributed in the same media and format in which it is obtained. The applicants have designed, deployed and tested an architecture to support the internal need for obtaining the desired raw data from outside sources and building a composite data repository that serves the need of this diverse user community.

In FIG. 2, an architecture 200 in accordance with the present invention is illustrated as comprising three layers. The Interface Layer 202 contains interface development tools 208 with which a user can specify a GUI/query string as in the DBMS solution discussed above, but the user can also specify special component-based functions that must occur before the query string can be created. The Middle Layer 204 contains a workflow control component 212 that creates a workflow based on instructions from a web-based GUI 210, which is preferably an HTML-based form, in the Interface Layer 202. Workflow control component 212 uses the workflow to sequentially execute the required business components. As aforementioned, there are a set of autonomous business components 214 that handle special functions such as the generation of dynamic queries, the incorporation of business rules, the generation of custom output formats, and data streaming to custom external applications. Data Storage Layer 206 includes the DBMS 218 to be accessed, which in turn may contains a database 215 and internal packages 216 for performing more rudimentary formatting functions.

The description below is organized into sections devoted to illustrating each of the aforementioned architectural layers in detail, followed by a description of an implementation of the invention at the CAASD.

1.0 The Interface Layer

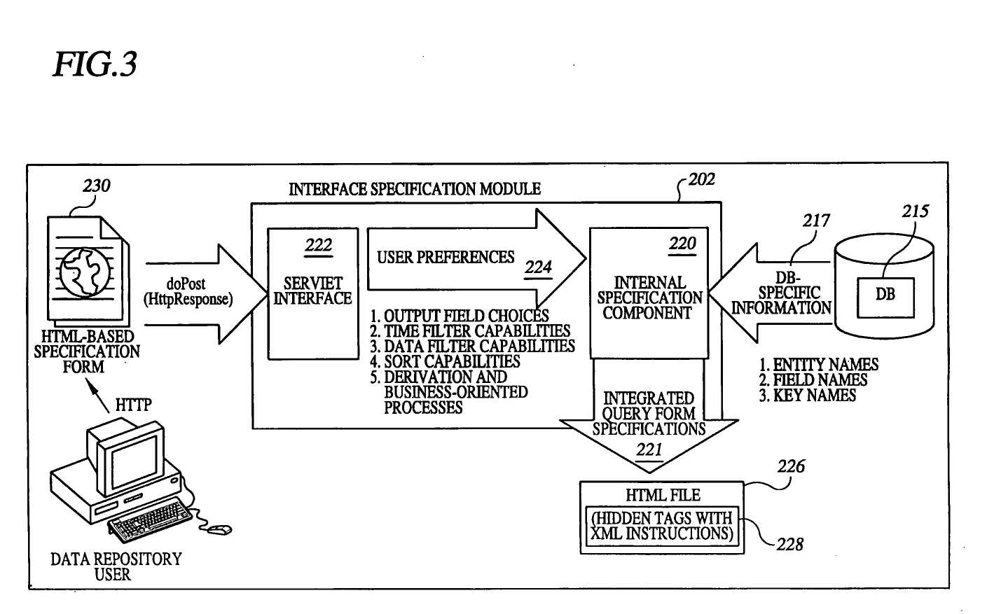

With reference to FIG. 3, Interface Layer 202 contains a Specification module 220 within the interface development tools 208 that allow the user to specify parameters and special processes that will be used in his/her data query. Specification module 220 can be accessed through the Internet, using a servlet-based interface 222. When a user accesses module 220, servlet 222 is used to present various options for selecting GUI query form specifications 221. Servlet 222 has access to database 215, so the options given to the user contain database-specific information 217. Once the user has completely specified his/her preferences 224, these choices are used to create an HTML file 226 for this specific user. HTML file 226 contains a hidden tag 228 with instructions for executing business-oriented components. Hidden tag 228 uses the Extensible Markup Language (XML) to represent the instructions. Other fields on the GUI query form created also have hidden information correlating HTML-based fields to columns of database 215. The main functionality of Specification module 220 is to gather the user preferences 224, combine the information with database specific information 217 and create HTML file 226.

1.1 HTML Hidden Tag and Instruction Fields

GUI query form 210 must contain information that both describes a GUI component and describes how that component is associated with database 215. This information can be represented using a name/value structure inherent to form-based HTML pages.

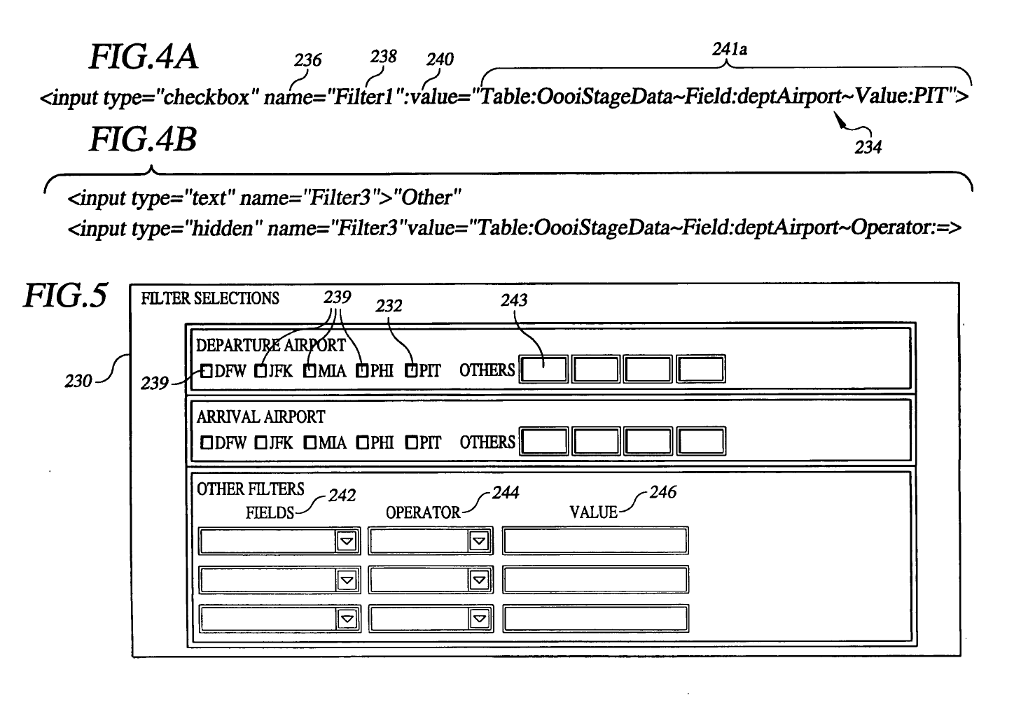

The HTML statement 234 shown in FIG. 4A implements an association between a graphical checkbox and a field of database 215. The HTML code implements the PIT checkbox 232 shown in the GUI of FIG. 5.

The HTML name 236 is equated to the component type 238, while the HTML value 240 equates to all the HTML value information 241.

The HTML name 236 of the fields contains only the types of components that are to be used, and since PIT checkbox 232 will be used as a simple filter of data, a Filter component type 238 will be required. The value information 241 of the fields contains the metadata describing the underlying table. String 234 is delimited by two characters. The name/value pairs are delimited from other name/value pairs by a “˜”. Each name is delimited from its corresponding value by a “:”. This is simply exemplary as alternative delimiters can be employed as appropriate for the system. In the example shown, a first name contains the metadata (Table) and its paired value contains the actual name of the database (OooiStageData). Name/value pairs can be concatenated together, to contain all required information to associate each field on GUI query form 210 with database 215. In most cases, there are multiple Filter checkboxes 239 on form 210. Therefore, the number “1” is appended to the name. This allows the architecture 200 to differentiate between components with the same functionality. In addition, it also allows the architecture to associate different fields on each form 210 and process them together if required. For instance, this occurs when a user needs to qualify information by greater than or less than operators. In the “Other Filters” example depicted in FIG. 5, a user has query options to specify a Field 242, Operator 244, and Value 246. Each of these HTML fields has different name/value pairs that must be connected.

Currently there is a case where a value tag cannot be used. This occurs when the user is entering values manually. In this case a hidden tag is used to contain the metadata. Both visible and non-visible fields will have the same name, e.g. both would have the name Filter3, and the system is able to process the two fields as if the information was contained on a single HTML statement. FIG. 4B is an example of HTML code that implements the user-entered textbox 243 (“Other”) in FIG. 5.

One skilled in the art will readily appreciate that many other GUI types and database specific functions exist beyond those shown in FIGS. 4A, 4B and 5 and are yet within the scope of the present invention. The aforementioned examples merely demonstrate some of the flexibility that is afforded by using metadata embedded in the HTML code.

1.2 HTML Hidden Business-Oriented Instructions

Another hidden tag tells the architecture how to support specialized functions. The following HTML code represents a hidden field used to instruct processing of information supplied from HTML form 230.

<input type=“hidden” name=“workflow” value=“Building SQL”>

Referring again to FIG. 2, the HTML code above shows a hidden tag used to specify a workflow of business components 214 that need to be called to complete this specific query form. The design of the business components 214 will be discussed below. Preferably, the name is equated to workflow to differentiate this hidden tag from other hidden tags, and only one workflow per form exists. The value of this tag specifies a particular workflow path to use. When the workflow control component (servlet) 212 is initialized, all available workflow paths are loaded into the system. These workflow paths are contained in multiple XML files. The purpose for using XML is to allow flexibility for future external applications to control the architecture by inserting their own XML instructions. These workflow-based XML files are located in a directory known by the architecture. The workflow path in XML corresponding to the particular HTML code above (Building SQL) can be implemented as in Table 1 that follows:

TABLE 1
<WorkFlow>

<WfPath>

<name>Building SQL</name>
<WfObject>

<name>StagedParser</name>
<Order>1</Order>

</WfObject>

<WfObject>

<name>QueryBuilder</name>
<Order>2</Order>
<WfMethod Order=“3”>BuildFrom</WfMethod>
<WfMethod Order=“2”>BuildWhere</WfMethod>
<WfMethod Order=“1”>BuildSelect</WfMethod>

<Parameter>

<Type>Number</Type>
<Value>10</Value>

</Parameter>
<Parameter>

<Type>String</Type>
<Value>“Select Distinct ”</Value>

</Parameter>

</WfMethod>
</WfObject>

<WfObject>

<name>OutputManager</name>
<Order>3</Order>

</WfObject>

</WfPath>

</WorkFlow>

This is a typical path for a simple form that requests a standard query. The first step is to parse information from the HTML GUI query form 210. A StagedParser object performs this task. The second step is to build a generic query based on information gathered from form 210. This process is performed using a QueryBuilder object. The final object is the OutputManager, which formats the query results into a format that the user specifies in form 210. As in the above code sniplet, the workflow can specify instructions at the method level. This is not typically the case, because most business components 214 are built with default functionality. However, in this case, the method-level specification shows that the QueryBuilder object will be building the specific clauses (Select, From, Where, etc.) of the resulting query. These method-level specifications show the flexibility of the architecture when default functionality is not possible.

1.3 Creating New GUIs

The process to create new HTML forms 210 is user-driven. Users enter a generic specification form 230 that asks a round of questions that eventually drills down to the tables in database 215 that the user is most interested. The user then has the ability to determine what value filtering, time filtering, sorting, grouping, etc., that he/she wants in the form 210 being created. These user preferences 224 determine the workflow of objects that must be executed to perform the task. This information can be parsed and used to generate specifications for HTML-based query forms. The user preferences 224 may be stored as an XML file, coupled with extracted database information, and jointly processed by an XSLT compiler with a generic XSL file to dynamically generate the HTML-based form 226 (i.e., a new GUI 210) with hidden tags 228 including metadata about the database and hidden information about the particular workflow needed to perform the query.

2.0 The Middle Layer

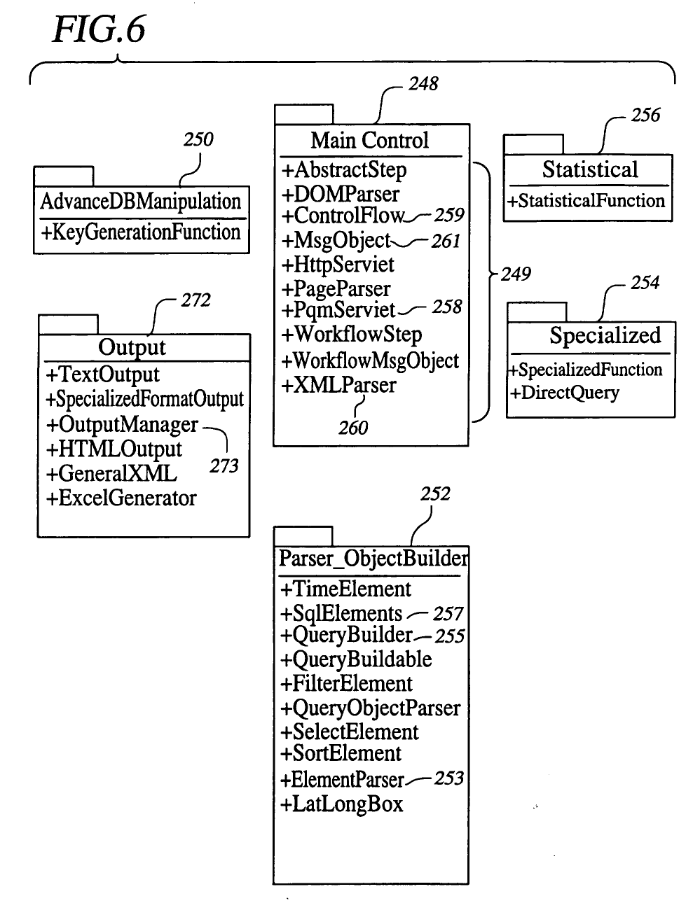

The middle layer 204 follows strict object oriented principles. The preferred embodiments described were conceptualized using the Unified Modeling Language (Booch et al., The Unified Modeling Language User Guide, 1998, Addison-Wesley, Reading, Mass., hereby incorporated by reference). Middle layer 204 contains all of the objects that execute the complex business rules, create the user specified queries and perform the complex data formatting. The middle layer is comprised, on a high level, of two parts, the Workflow Control component 212 and the group of Autonomous Business components 214. Currently, these parts are implemented with five components. With reference to FIG. 6, the five components are the MainControl 248, AdvanceDBManipulation 250, Parser_ObjectBuilder 252, Specialized 254, and Statistical 256 components. In this architecture, each of the components is comprised of a separate group of classes that perform independent functionalities. For the purpose of clarity, the components can be represented in packages (as defined in the Unified Modeling Language).

2.1 Workflow Control Component

The Workflow Control component 212 is the part of the architecture that controls what steps will be executed in building the database query and returning the relevant information. Workflow has been defined in many contexts over the past decade. As used herein, the workflow is defined as the specification and execution of a sequence of steps or processes to accomplish a specified job. One problem in most systems is that the workflow can have business rules that are predefined. By essentially “hard-coding” their functionality, these systems are not easily extended. In fact, major revisions are necessary to incorporate even minor enhancements to functionality. However, the Workflow Control component 212 defined here is an extensible component that allows the workflow to be designed at run-time as illustrated in Section 1.2. Workflow Control component 212 then executes the Autonomous Business components 214 specified in the workflow.

2.1.1. Main Control Package

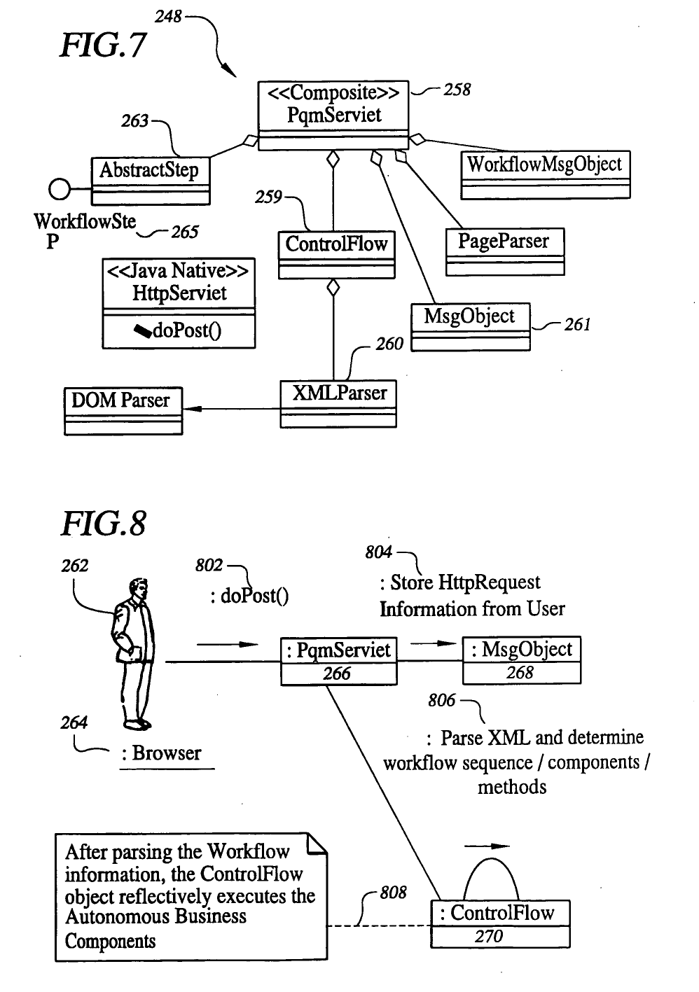

MainControl package 248 is responsible for implementing the Workflow Control component, and contains independent classes 249 that can organize, order, and execute the workflow, according to a pre-defined workflow path (e.g., the XML document in Section 1.2). The main classes of this package are the PqmServlet 258, ControlFlow 259, XMLParser 260, and the MsgObject 261. PqmServlet 258 (PQM stands for Presentation Query Management) captures request information that the user submits via the HTML query form 210. ControlFlow 259 is the main workflow execution engine, responsible for reflectively executing the autonomous business components 214 (that will be described below). XMLParser 260 parses the workflow path and captures the information in memory. Finally, MsgObject 261 includes generic data structures that store information that is passed among the autonomous business components 214. Since the business components are autonomous, the passed information is typically information at the workflow-level. A class diagram for MainControl package 248 with the aforementioned classes is illustrated in FIG. 7.

As illustrated in the collaboration diagram of FIG. 8, the workflow execution process can be generally summarized in four basic steps. In Step 802, when a user 262 presses a submit button on an HTML browser 264, a doPost( ) method is automatically executed on PqmServlet 266. In Step 804, PqmServlet 266 populates the MsgObject object 268 with the user's request information (via Java's HTTPRequest). In Step 806, control is passed over to the ControlFlow object 270. ControlFlow first parses the XML-based workflow path. Finally, in Step 808, ControlFlow object 270 uses the workflow information from the XML document and HTTPRequest to create and execute the default or specified entry method for each of the Autonomous Business components 214.

2.1.2 Reflective Capability of the ControlFlow Class

A beneficial feature of architectures in accordance with the present invention is the ability to execute new workflow paths at run-time. Reflective architectures or software can be configured and executed at run-time without compile-time dependencies. The preferred architecture of the present invention is a run-time evolvable framework, which uses reflection to convert text-based instructions into software executions. The ControlFlow class 259 has a simple method written in Java™ that performs the reflective execution. The code sniplet listed in Table 2 illustrates the use of Java reflection.

TABLE 2
Sniplet of Reflective Code Syntax

```
public class ControlFlow {
  private MsgObject messageObject = new MsgObject();
  public AbstractStep crsObject;
  // Parent class of all plug-able components
```

/***Controller***/
public ControlFlow(MsgObject thisMessage)
{

messageObject = thisMessage;

}
/***Method to create the Object****/
public void createObject(String className)
throws ControlFlowException
{

| Object object = null; | |
|---|---|
| try | { |

Class classDefinition = Class.forName(className);

crsObject = classDefinition.newInstance();

```
crsObject.execute(messageObject);
  }
  // (CatchExceptions...)
```

As shown, the ControlFlow object takes MsgObject as a parameter. This will be the container that the Autonomous Business components 214 use to pass information. The purpose of MsgObject is to provide global workflow-level information without becoming coupled to any specific component. Therefore, MsgObject contains only implementations that help store and retrieve global information. The createObject method takes className as specified in the XML-based workflow path and reflectively creates an instance of the class. This instance is used to polymorphically run a generic execute function that is contained in all the Autonomous Business components 214. This is one of many cases where the present invention exploits the strength of object-oriented programming.

2.2 Autonomous Business Components

The Autonomous Business components 214 are implemented in several packages. In the embodiment of FIG. 6, these packages are the AdvanceDBManipulation 250, Output 272, Parser_ObjectBuilder 252, Statistical 256, and Specialized 254 packages. Each of these packages implements a specific autonomous function toward the data extraction job. AdvanceDBManipulation package 250 is used to collect specific table information from the HTML files and build the complex joins between database tables needed in some data queries. Output package 272 is used to convert the query results into various query output format options as specified by the user. Statistical package 256 has internal algorithms that derive the query results based on certain algorithmic criteria. Specialized package 254 is used to capture all functionality that cannot be generic. One such function implemented in this package is the ability for a user to directly type in a database query in SQL and have it returned in a specified format. Finally, Parser_ObjectBuilder package 252 has classes that build a generic query from HTML. This package understands request information and generically builds a standard database query string. It is not the goal of the applicants to define here in detail all of the possible Autonomous Business components 214 that could be employed in alternative embodiments of the present invention. The classes in Parser_ObjectBuilder 252 were selected for explanation because this package is useful to the generic SQL query generation.

2.2.1 The Parser ObjectBuilder Package

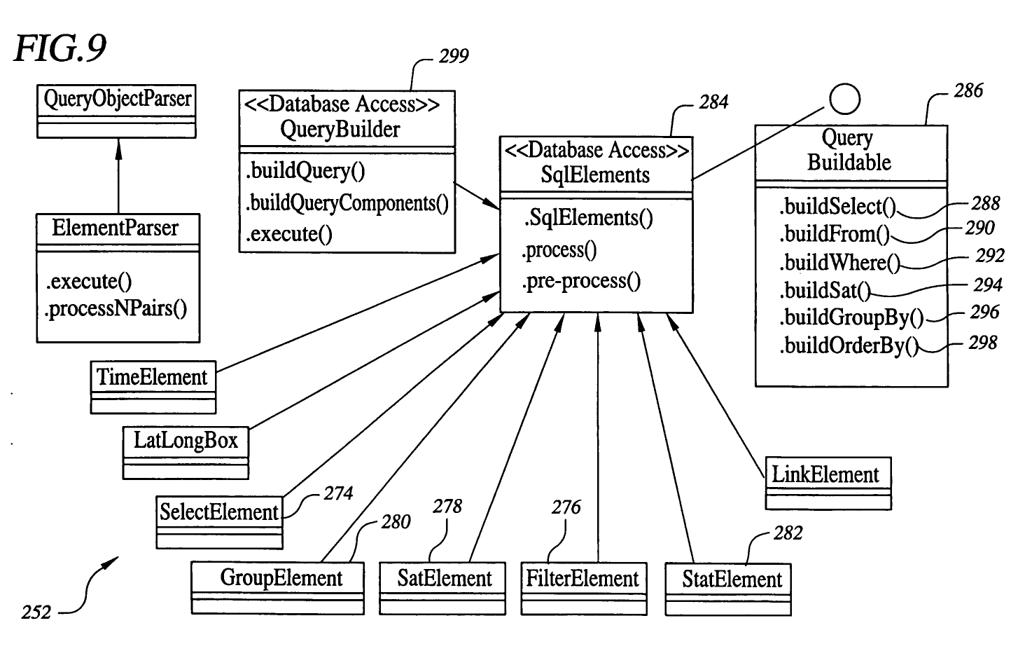

A class diagram of Parser_ObjectBuilder package 252 is illustrated in FIG. 9. This package exemplifies the most general process that may be used by any specified workflow path that displays data from the database. In this architecture, independent buttons and fields from the HTML query form have direct relations with the underlying query that will be built. There are underlying classes in this package that associate fields from the HTML form 210 with the underlying database. The duties of these classes are to understand the HTML fields and create an SQL query. The typical classes are SelectElement 274, FilterElement 276, SortElement 278, GroupElement 280, and StatElement 282. Each of these classes are derived from the SqlElement class 284. The SqlElement class implements the common Java interface QueryBuildable 286. By implementing QueryBuildable, the SqlElement and each of its derived classes must implement the methods buildSelect 288, buildFrom 290, buildWhere 292, buildSort 294, buildGroupBy 296, and buildOrderBy 298. Intuitively, these methods will create the part of the query relevant to the Select, From, Where, Sort By, and Group By SQL blocks. The functions of these classes can be summarized as below.

SelectElement: converts HTML fields to columns to be displayed from the database.

FilterElement: converts HTML fields to restrictions in the dataset displayed.

SortElement: converts HTML fields to order in which results are displayed from the database.

GroupElement: converts HTML fields to groupings that data is displayed from the database.

StatElement: converts HTML to statistical functions such as Count( ).

A QueryBuilder class 299 collects the list of all SqlElements for a given query. The QueryBuilder class 299 passes in an empty SQL string that continually gets populated as the interface methods are called for each of the derived SqlElements (274,276,278,280,282). This is an advantageous use of object-oriented programming by the present invention, demonstrating information hiding, encapsulation, and polymorphism as each SqlElement is responsible for its own behavior. These elements also are called polymorphically using the build . . . methods (288,290,292,294,296,298) each of which is implemented via the QueryBuildable interface 286.

2.2.2 Adding New Business Components

As aforementioned, the Autonomous Business components 214 are independent. Each component has an interface class that contains an execute method. This execute method is polymorphically called by the ControlFlow class 259 as depicted in FIG. 7. With this design, new business components can be added seamlessly or through software plug and play [for a detailed discussion, refer to Bronsard et al., “Toward Software Plug-and-Play”, In Proceedings of the 1997 Symposium on Software Reusability pp. 19-29, the contents of which are hereby incorporated by reference]. When a new component is added, it merely needs to be derived from the AbstractStep class 263 contained in the MainControl package 248. AbstractStep class 263 has the interface WorkflowStep 265. The WorkflowStep interface defines the execute method. Subsequently, when a text-based instruction uses the new component in a workflow path, then the execute method would be called by default unless, as discussed in Section 1.2, specific functions are declared.

3.0 The Data Storage Layer

The Data Storage Layer 206 is somewhat customary, being comprised of a typical relational DBMS 218 capturing the data in the architecture. As an example, the DBMS 218 in one preferred embodiment is Oracle version 8i™. The architecture 200 does not require that data be normalized, but some normalization helps in the performance of the system as a whole. The following are database functions that preferred embodiments of the present invention take advantage of:

Stored procedures to perform simple formatting (date, times, latitude, longitudes, etc.)

Some formatting is easily accomplished using the database server rather than exterior Java-based processing. However, more stored procedures may be added to further remove some generic functionality from the code. One such functionality may be the addition of drill-down features.

Meta-data to translate database column names into relevant English names The system uses a generic query process that uses the direct column names to generate the query. There are meta-data tables in database 215 that help the architecture translate database-specific column names into the more “user-friendly” names. However, there is also support in the architecture for the “user-friendly” name to be specified in the HTML form.

Indexing for large tables

As with most relational DBMSs, the performance of the architecture 200 is dependent on an accurately indexed system. A database administrator performs the indexing. Indexes are typically created and updated regularly at low peak hours.

4.0 The CRS Architecture

This section describes an architecture that was developed at the MITRE Corporation, assignee of the present application, in accordance with the present invention. It will provide an overview of the system that was developed, walk through the query-building process, and show some actual forms used in the process.

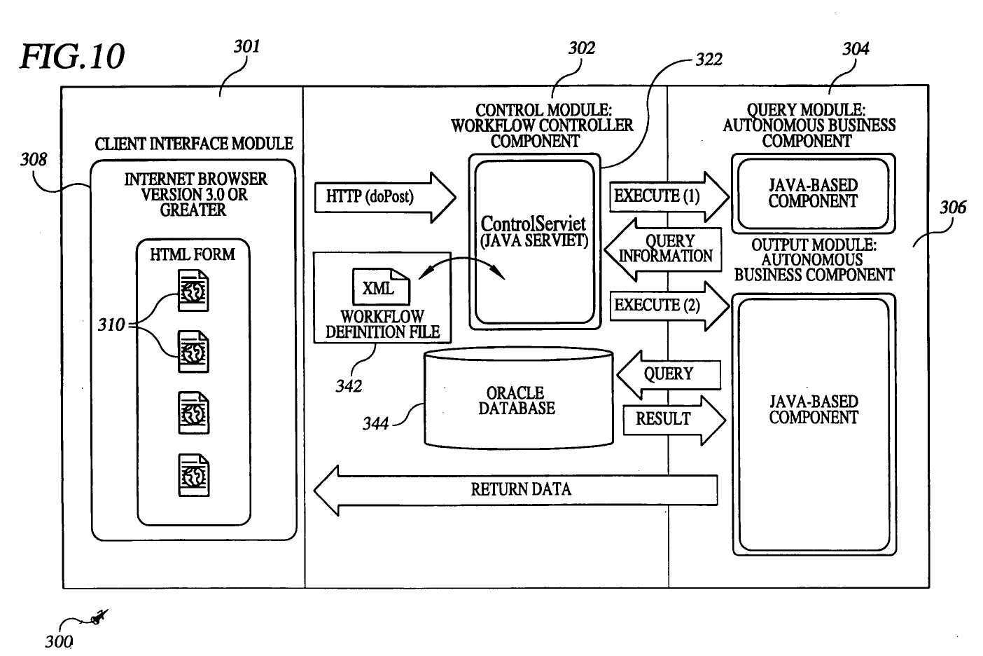

FIG. 10 presents an implementation 300 that parallels architecture 200 as described above. The CRS implementation 300 primarily uses Java-based technologies. The three basic functionalities required in extracting data have been separated into three modules, the Control Module 302, Query Module 304, and Output Module 306. The remainder of this section will discuss these modules with reference to the Distributed Data Management architecture 200 described above.

One or more browsers 308 in the Client Interface Module 301 connect to a Java Servlet-based interface (ControlServlet 322), which passes user information to the Control Module 302. ControlServlet 322 serves as the main interface between the user and Control Module 302. The servlet accepts information from the browsers 308 in the form of an HttpServletRequest. The user's data and format criteria are encapsulated in the HttpServletRequest. As described in Section 2.1.1, this information is parsed and stored in a Java object, the MsgObject 261. MsgObject 261 is essentially passed to all the steps in turn. Each step extracts what it needs from MsgObject 261 and modifies its contents, if necessary.

4.2 Description of the CRS Modules

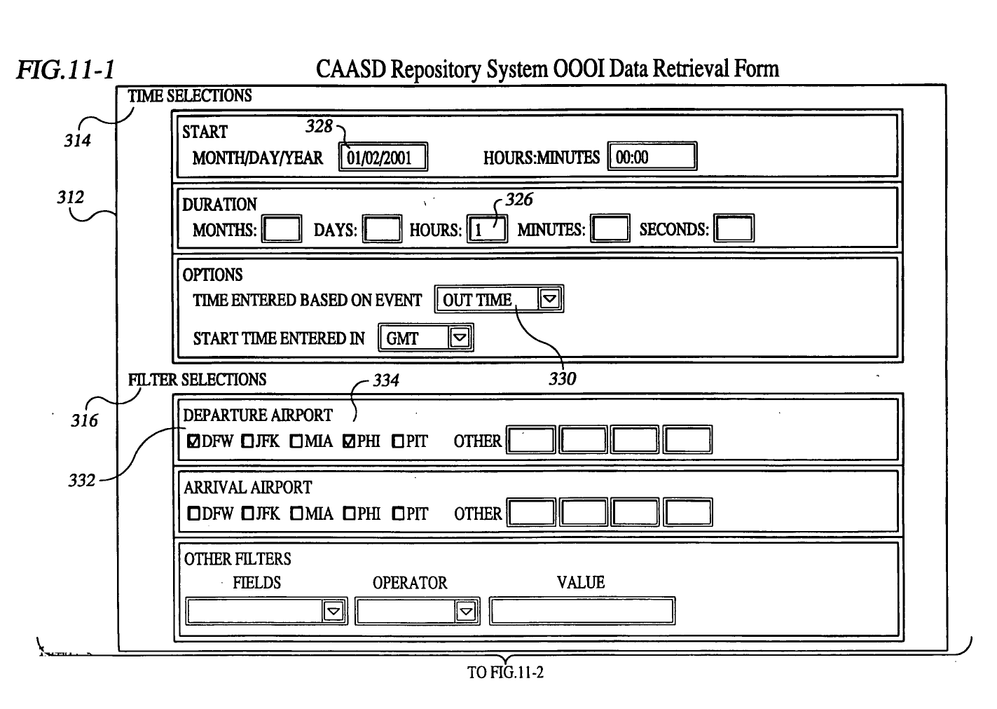

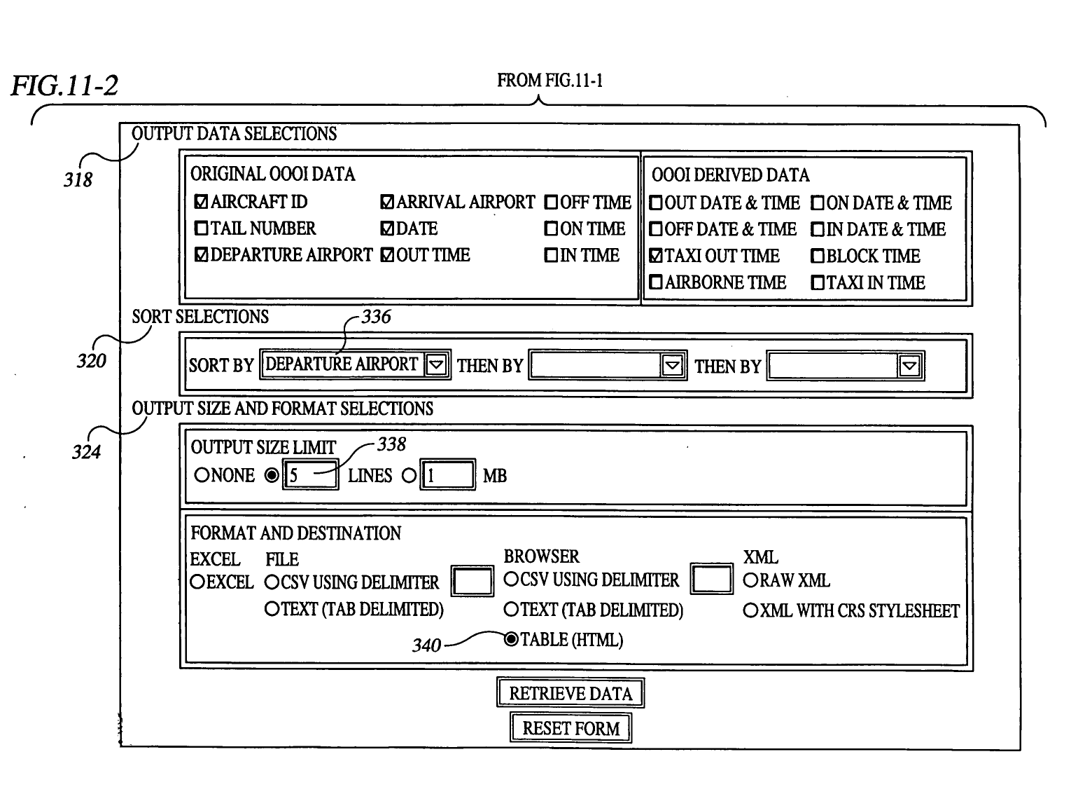

Each Client Interface Module 301 is simply the web browser used by users of the CRS system. Typically, the users access one or more standard query forms 310 based on the dataset that they are interested in. One particular data schema of the CRS system that relates to Air Traffic Management (ATM) is the OOOI data set. This data set deals with the Out/Off/On/In times when a plane backs “out” from a terminal, lifts its wheels “off” the runway, lands back “on” an arrival runway, and finally pulls “in” to an arrival airport terminal. The query form illustrated in FIG. 11 is an example that is compatible with the CRS distributed data management system.

Form 312 is separated into 5 sections. The first section, Time Selections 314, allows the user to specify a particular time range used to filter the output information. The second section, Filter Selections 316, allows the user to specify filter constraints based on return values. The Output Selections 318 section allows the user to determine what columns are requested as output. Sort Selections section 320 allow the user to determine how the data should be sorted. Sort Selections section 320 requires that sorted columns also be selected in Output Selections 318. Finally, Output Size and Format Selections section 324 allows the user to limit the quantity of output, as well as specify what format is desired as the return. In this particular case illustrated, the request is for one (1) hours worth of information 326 starting at Jan. 1, 2001 midnight 328. This information will be based on the time flights back out 330 of the terminal. These choices are seen in the Time Selections section 314. In addition, this request will return only information on flights departing either Dallas airport 332 or Pittsburgh airport 334 (as selected in Filter Selections 316).

Output Data Selections section 318 shows various airplane and airport related information that will be returned for each entry. And based upon the choices designated in Sort Selections section 320, the results will be sorted by the departure airport 336. Finally, in the Output Size and Format Selections section 324, the output is limited to 5 lines 338 and will be returned as HTML table 340.

Referring again to FIG. 10, Control Module 302 is implemented with an XML file 342 and several Java classes. The main purpose of this module is to take the information workflow information and orchestrate the execution of the appropriate modules. XML file 342 contains a listing of all the workflows supported along with the choice of and order of modules to execute. The module parses the XML file to find the appropriate workflow. The OOOI dataset uses the XML file (workflow) depicted in Table 1.

Query Module 304 is an example of an Autonomous Business component 214 implemented with Java classes. As described in Section 2.2.1, SqlElement objects are created and used to create a SQL database query string. Consequently, the resulting query string is stored in MsgObject 261 for retrieval by the Output Module. The query string associated with the OOOI example of FIG. 11 is:

SELECT DISTINCT OooiStageDa.carrierFlight, OooiStageDa.deptAirport, OooiStageDa.arrAirport, OooiStageDa.gmtdate, OooiStageDa.outtime, OooiDerivedTi.taxiouttime

FROM OooiStageData OooiStageDa, OooiDerivedTime OooiDerivedTi

WHERE ROWNUM < 6 AND OooiDerivedTi.OooiDataId=OooiStageDa.OooiDataId AND OooiDerivedTi.outtime >= to_date(‘2001-01-02 00:00:00’, ‘YYYY-MM-DD HH24:MI:SS’) AND OooiDerivedTi.outtime <= to_date(‘2001-01-02 01:00:00′’, ‘YYYY-MM-DD HH24:MI:SS’) AND (OooiStageDa.deptAirport= ‘PIT’ OR OooiStageDa.deptAirport= ‘DFW’)

ORDER BY OooiStageDa.deptAirport

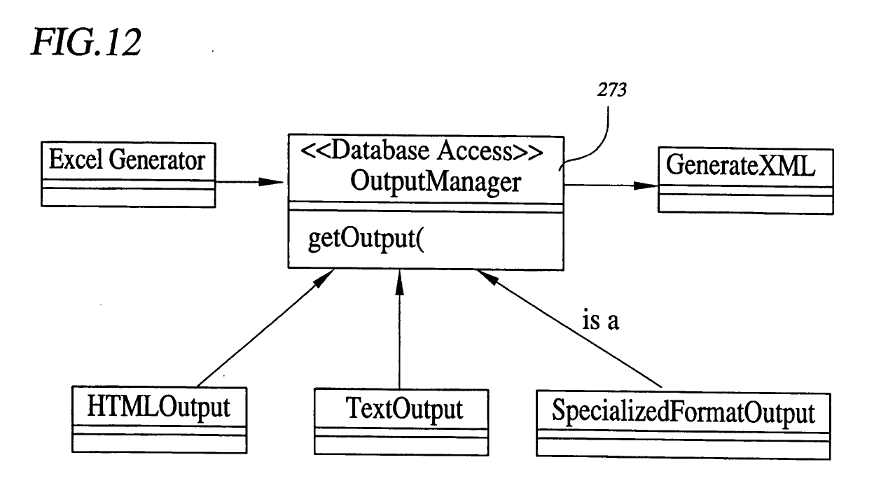

Output Module 306 is also an Autonomous Business component, one that is basically a customized interface to DBMS 344 (which is shown as an Oracle™ database). This is not a new technology as many vendors have constructed APIs for DBMSs. Here, the applicants specialized one of those APIs for use within the CRS architecture. In this implementation, the applicants use Sun Microsystems' JDBC methods to connect to an Oracle database. All database and user interaction is run in the Output Module to help performance. The main class in the Output Module is the OutputManager (shown in FIG. 12 and reflected as element 273 in the Output Module 272 of FIG. 6). This object extracts the query from MsgObject 261 and submits the query to the DBMS. Once the result set is available, it returns the data in the specified format. This class is specialized to generate HTML, ASCII, XML, Excel, and any other customized format that may be desired. This Output Module is independent of the query builder and database so that a change in either will not affect its functionality.

4.3 The Data Extraction Process

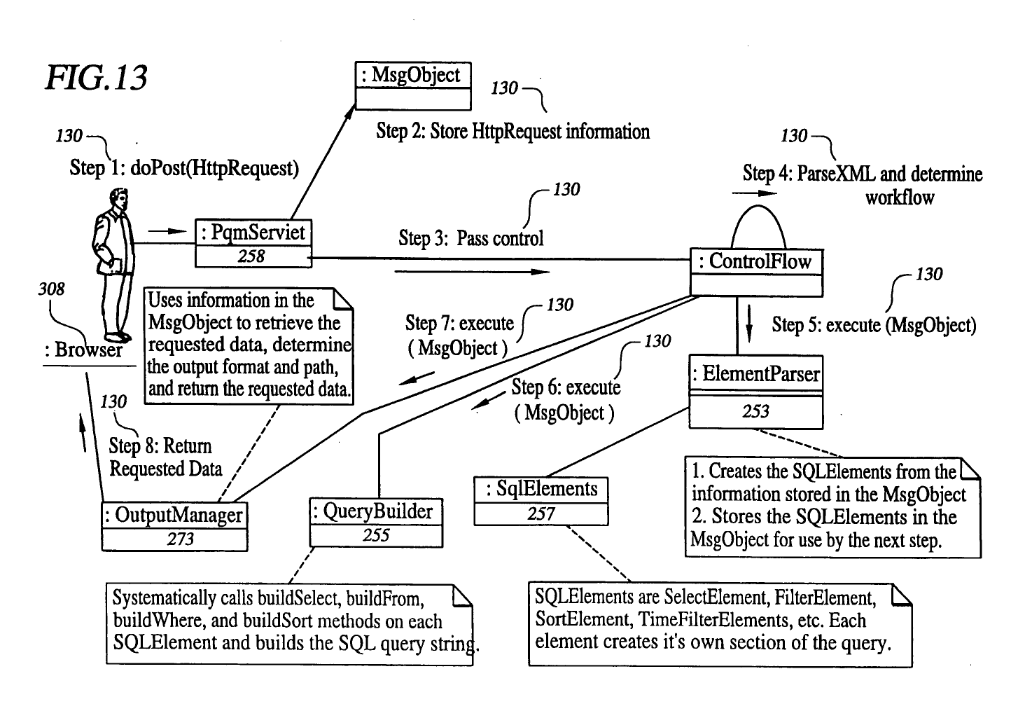

In FIG. 13, a collaboration diagram is used to show the sequence of events in creating query strings and returning results.

The following is a list of software executions taken in the collaboration diagram in FIG. 13.

In Step 1301, the doPost( ) event is captured by the ControlServlet and also PqmServlet 258.

In Step 1302, the ControlServlet then stores the information, including the name of the workflow, contained in the doPost( ) message in the MsgObject for retrieval by the downstream modules.

In Step 1303, the ControlServlet creates a Control Flow object, which identifies which modules are to be used. (In this case the standard Query Module and OutputManager Module will be used).

In Step 1304, the name of the workflow is checked against pre-defined workflows in the XML file 342 to determine the module and classes (and optionally, the methods) to be called and sequence of execution.

In Step 1305, two steps are executed in the Query Module, performed respectively by ElementParser 253 and QueryBuilder 255. ElementParser 253 is called first and creates SQLElements 257 from the information stored in the message object. As each element is created, it is stored in MsgObject for use by QueryBuilder 255.

In Step 1306, QueryBuilder 255 systematically calls buildSelect, buildFrom, buildWhere, and buildSort methods on each SQLElement, which builds the query string.

In Step 1307, OutputManager 273 is then called with the default method to retrieve and return the requested data in the correct format.

And finally in Step 1308, the data is returned to the client browser 308 and either viewed or saved for later use.

4.4 OOOI Query Results

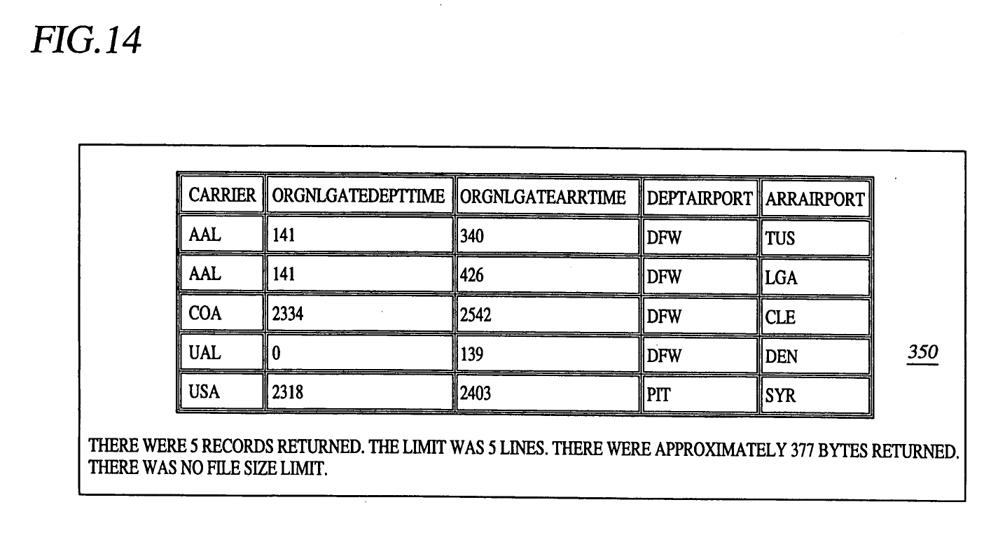

Results for the specific query described above are reflected in the resulting HTML table 350 shown in the screen dump illustrated in FIG. 14. As specified in the query form, the result for this particular query is an HTML table that shows 5 rows. Each row contains the airline/airport data for flights that departed from Dallas or Pittsburgh airports.

By maintaining the autonomous nature of the component modules, architectures in accordance with the present invention can adapt in the future with minimal lapses of services. Because the modules are ignorant of the database schemas, this system can be reused for any data schema with minimal effort. The users of this system have merely to understand the output data, formats, and types of filters to operate this implementation.

Moreover, as business needs change, the system can adapt to the corresponding changes quickly and easily.

Other embodiments of the invention will be apparent to those skilled in the art from a consideration of the specification or practice of the invention disclosed herein. For instance, although the primary embodiment described involves an air traffic domain, the invention has applicability to numerous other domains (e.g., military strategic motions and telemetry). It is intended that the specification and examples be considered as exemplary only, with the true scope and spirit of the invention being indicated by the following claims.

What is claimed is:

1. A run-time evolvable distributed database management architecture, comprising:
a data storage layer including a database management system for managing a database;
a dynamic generator of an HTML-based interface to the data storage layer based upon user preferences and database-specific information; and
a control module including one or more autonomous business components, the control module for creating at run-time a workflow sequence for executing the autonomous business components and executables of the data storage layer in response to instructions received via the interface in order to retrieve and format data from the database.

2. The architecture of claim 1, wherein the database-specific information comprises meta-information relating to tables of the database.

3. The architecture of claim 2, wherein the meta-information has been automatically extracted from the database.

4. The architecture of claim 1, wherein workflow component configuration and execution information based upon the user preferences and the database-specific information is embedded within the standard mark up syntax of the interface.

5. The architecture of claim 4, wherein the workflow information is further comprised of a hidden tag and a control XML file

6. The architecture of claim 5, wherein the XML file is processed with a deployment specific XSL file to dynamically generate the interface.

7. The architecture of claim 1, wherein the control module further comprises Java servlets and classes to reflectively convert the instructions into a workflow sequence.

8. The architecture of claim 1, wherein the control module is evolvable to allow addition of new executable business components at run-time.

9. The architecture of claim 8, wherein the new business components are added by derivation and by inclusion of a name and associated execution links in the control XML file.

10. The architecture of claim 1, wherein the dynamic generator further comprises a set of servlets for accepting the user preferences from a browser and parsing the user preferences in order to generate specifications for new parts of the interface.

11. The architecture of claim 1, wherein the interface comprises a network-accessible query form for display on a user screen and the instructions comprise query inputs.

12. The architecture of claim 1, wherein each of the autonomous business components perform independent database data specification or extraction tasks.

13. The architecture of claim 1, wherein each of the autonomous business components has a polymorphic executable interface callable by the control module.

14. The architecture of claim 1, wherein the autonomous business components perform some or all of the following functions: specification of desired data, extracting specific database table information from the user instructions, building joins between tables of the database, and formatting of data retrieved from the database.

15. The architecture of claim 1, wherein one or more of the autonomous business components perform domain specific functions.

16. The architecture of claim 15, wherein the domain-specific function comprises capturing user instructions entered employing directly the language of the database management system or further processing of data received from the database prior to providing it to a user.

17. The architecture of claim 1, wherein the dynamic generator further comprises a servlet having access to the database management system that when executed:
presents a query-form-building interface including selectable database-specific information; and
generates an XML file based on information selected through the query-form-building interface.

18. The architecture of claim 1, wherein execution of the autonomous business components per the workflow sequence results in the generation of one or more dynamic queries for processing by the database management system.

19. The architecture of claim 19, wherein execution of the autonomous business components per the workflow sequence results in the incorporation of business rules in the dynamically generated queries.

20. The architecture of claim 1, wherein execution of the autonomous business components per the workflow sequence results in custom formatting of data extracted from the database in accordance with the user instructions.

21. The architecture of claim 1, wherein execution of the autonomous business components per the workflow sequence results in data streaming of the data extracted from the database to external applications.

22. The architecture of claim 1, wherein the interface includes embedded hidden tags correlating fields of the interface to fields of the database, and the user requirements for those fields.

23. The architecture of claim 1, wherein execution of the autonomous business components per the workflow sequence can be called from a Java Servlet, Applet, or a local or remote application.

24. A meta-language operable in a computer for extending a distributed data management system, comprising:
a text-based syntax combining graphical user interface development semantics and database query semantics, wherein the syntax allows embedding of workflow component configuration and execution information based upon user preferences and database-specific information within a standard mark-up syntax of a graphical interface; and
an interpreter for translating portions of the syntax and received user inputs into a dynamic query for processing by a database management system.

25. A method for providing a run-time evolvable distributed database management architecture, comprising:
providing an interface to a data storage layer including a database management system for managing a database;
dynamically generating an HTML-based interface to the data storage layer based upon user preferences and database-specific information; and
creating at run-time, with the aid of one or more autonomous business components, a workflow sequence for executing the autonomous business components and executables of the data storage layer in response to instructions received via the interface in order to retrieve and format data from the database.

26. A computer program product for providing a run-time evolvable distributed database management architecture, comprising a computer usable medium having computer readable program code thereon, including:
program code for accessing a data storage layer including a database management system for managing a database;
program code for dynamically generating an HTML-based interface to the data storage layer based upon user preferences and database-specific information; and
program control code including one or more autonomous business components, the control code for creating at run-time a workflow sequence for executing the autonomous business components and executables of the data storage layer in response to instructions received via the interface in order to retrieve and format data from the database.
